(19) United States
(12) Patent Application Publication
(10) Pub. No.: US 2025/0215602 A1
(43) Pub. Date: Jul. 3, 2025

(54) APPARATUS FOR TREATMENT OF ELECTRODES

(71) Applicant: Latent Drive Ltd, Dorset (GB)

(72) Inventors: Joseph Rowan Ely, Sherbourne (GB); Frazer Ely, Poole (GB)

(21) Appl. No.: 18/881,438

(22) PCT Filed: Jun. 26, 2023
(86) PCT No.: PCT/GB2023/051662

§ 371 Date: Jan. 6, 2025

(30) Foreign Application Priority Data
Jul. 6, 2022 (GB) 2209930.3

(51) Int. Cl. C25D 11/02; C25B 11/052; C25B 11/061; C25B 11/077; C25D 11/34; H02M 1/44

(52) U.S. Cl. CPC C25D 11/024; C25D 11/34; H02M 1/44; C25B 11/052; C25B 11/061; C25B 11/077

(57) ABSTRACT

Apparatus is provided for treating an electrode in an electrochemical cell. The electrode is treated to evolve catalytic oxide layers on the electrode surface, which make the electrode suitable for use in hydrogen production. The apparatus includes a signal generator, a switching arrangement, and a filtering stage including a differential choke and the common mode choke, to supply power to the electrochemical cell for commercial scale treatment and production of electrodes.

The present invention relates to a method of manufacturing an electrode, particularly an electrode suitable for use in hydrogen production by electrolysis.

### BACKGROUND TO THE INVENTION

Hydrogen has enormous potential as a clean fuel which produces no greenhouse gas emissions. “Green” hydrogen is produced by electrolysis of water. The process of hydrogen production can be powered by renewable electricity, for example wind and solar, and in particular can be turned on at times of excess renewable generation. The hydrogen can then be stored and transported through the same gas distribution as is currently used for natural gas. Hydrogen is a proven fuel for heating and household use-town gas or coal gas used in past decades was around 50% hydrogen. Hydrogen also has potential as a vehicle fuel. Hydrogen can also be burned in gas turbines to generate electricity at times of low renewable generation, e.g. on dull still winter days when there is little wind and little solar. Hence hydrogen may be an effective way to “time shift” renewable generation.

In practice, scaling up production of green hydrogen has been severely limited by the dependence on rare and expensive catalysts such as iridium and platinum, used to catalyse the electrolysis. The world supply of these metals may not be enough to scale up green hydrogen production to the extent necessary to displace fossil fuel use, move to fully renewable generation, and avert climate change.

Some current electrolyser designs use MEAs (membrane electrode assemblies). In these electrodes, nano particle catalysts (made from expensive materials) are supported on larger inert conductive particles. The resulting powder is then coated and bonded to porous metallic substrates and membranes using specialist ion conductive polymers. This process is complex and expensive, and the end product is prone to delamination and catalyst loss under demanding operating conditions.

In an attempt to overcome this difficulty, researchers have focused on modifying the properties of common metals so that they can be used in place of the iridium and platinum. It has been found that stainless steel can be treated in an electrochemical cell to produce catalytic oxides on the surface. Researchers have demonstrated this using laboratory equipment which is designed for cyclic voltammetry—an electrochemical measurement technique. For example, see Zhang et al., Cathodic activated stainless steel mesh as a highly active electrocatalyst for the oxygen evolution reaction with self-healing possibility, Journal of Energy Chemistry (2020). This team use laboratory potentiostats to demonstrate cathodic activation of a stainless steel electrode. However the size of the electrode realised is very small, around 1 cm². The laboratory equipment used simply cannot deliver enough power to scale up to a useful size.

A typical 1 MW electrolyser requires more than 600 electrodes, each having an area of about 1000 cm². The small-scale laboratory trials, while proving the theory, are a long way from delivering electrodes at even this scale. In the meantime hydrogen electrolysers are now being built at 10 MW or 100 MW scale or even larger.

Laboratory potentiostats use linear amplifiers made from op-amps and transistors to produce a very smooth and precise electrical output. This smooth and precise output is critical to the success of the activation technique since a steady flow of charged particles is required in the electrochemical cell. However, a large amount of heat is dissipated in a linear amplifier operating at part load. In the activation techniques used, the process repeatedly and slowly cycles through low voltages, meaning that the power lost to resistive heating is far greater than the power applied to treat the electrode—the process is very inefficient and, at the power levels required to produce electrodes of a useful size, this inefficiency and level of waste heat would be a considerable problem.

It is an object of the present invention to reduce or substantially obviate the aforementioned problems. In particular it is an object of the invention to provide a high-power potentiostat or DC power supply for electrochemical treatment of electrodes, and to produce electrodes at commercial scale using common materials, which are cheaper and more robust than currently known electrodes.

### STATEMENT OF INVENTION

According to the invention there is provided an apparatus for supplying current to electrodes in an electrochemical cell, the apparatus comprising:
a control system for producing a control signal;
a DC power supply having positive and negative terminals;
a switching device configured to switch the DC power supply according to the control signal from the control system by pulse width modulation;
a filtering arrangement connected to the output of the switching device, for smoothing the output from the switching device and providing a pair of smoothed output terminals for connection to electrodes in an electrochemical cell,
DC isolation being provided between the smoothed output terminals and the positive and negative terminals of the DC power supply.

The apparatus of the invention provides the smooth and precise output which is required for the cyclic electrolytic treatment process to work. The switching device is able to provide a high power and high frequency switched signal, which is then smoothed to provide the precise output required for electrolytic treatment. The switched and filtered output can deliver much higher power than a laboratory potentiostat.

The switching device is controlled to switch at for example about 20 kHz or higher, such as about 60 kHz, 100 khz or 200 kHz, to output a square wave. The switching is controlled in order to set the mean output voltage of the square wave, i.e. by pulse width modulation. The output from the switching device is essentially a PWM signal, with a mean output voltage according to the control signal.

The square wave may have a variable mark-space ratio.

The filtering arrangement smooths the square wave to a steady voltage output.

The smoothed output signal, which in use is connected to electrodes in an electrochemical cell, is isolated from the DC power supply. In other words, the DC voltage of smoothed output terminals is floating relative to the DC voltage of either of the power supply terminals. Preferably, one of the smoothed output terminals may be connected to a physical ground, i.e. earth, and/or a chassis ground. This is convenient because the grounded output terminal can then easily share a ground with, for example, a mains-powered computer forming part of the control system. In this case, the DC power supply will not be earthed, and typically the negative side of the DC power supply will be treated as a floating ground.

The arrangement of the invention can supply typically 200-300 A or more, at a voltage of up to around ±10V.

Preferably, the filtering arrangement includes inductors and capacitors arranged as a low-pass filter. Preferably, the filtering arrangement includes a differential choke and a common mode choke.

Critically, the arrangement which uses the switching device to control voltage provides very efficient control, with minimal resistive heat losses. The apparatus can be realistically used to treat electrodes with a surface area of up to about 1 m² (10,000 cm²). This can then be cut down to make multiple electrodes for use in green hydrogen electrolysers. The equipment can also be duplicated with affordable capital costs, and without creating impossible heat management problems.

The switching device at any particular instant is either fully “on” or fully “off”, rather than operating in mid-conduction like a conventional linear amplifier, typically used as laboratory equipment. Therefore, the use of a switching device is more efficient and wastes minimal power.

The switching device may include an H-bridge circuit, having two input lines, two output lines, and four switching elements. A first switching element is provided between the first input line and the first output line. A second switching element is provided between the second input line and the first output line. A third switching element is provided between the first input line and the second output line, and a fourth switching element is provided between the second input line and the second output line. The switching elements may be transistors, for example MOSFETs. Importantly, an H-bridge arrangement can provide four quadrant control, i.e. it can supply voltage at either polarity, and with current flow in either direction. This is important in electrochemistry where the cell reactions may be driven by power input, or they may generate power which has to be controlled and absorbed.

The switching device operates at a high frequency, typically around 20 kHz or above. The use of higher frequencies greatly reduces the difficulties and costs of smoothing the output. At around 100 kHz or above the inertia of the ion flow and capacitance effects predominate, and the ion movement no longer follows the square wave of the driving voltage.

The control system is preferably electrically isolated from the switching arrangement, with the control signal being passed from the control system to control the switching arrangement, for example via an opto-isolator.

The input lines of the switching arrangement are connected to the positive and negative sides of a DC power supply.

DC isolation may be provided between the control system and the switching device to accommodate floating voltages.

The DC power supply is able to both source and sink current. The DC power supply may be for example a battery which is capable of both supplying power and absorbing power. In a preferred embodiment, the DC power supply includes a mains-powered supply (e.g. a transformer and rectifier) and also includes a battery. This forms a supply which is capable of both supplying power and absorbing power. This enables voltage control to be maintained through the full four quadrants of polarity.

The switching arrangement is controlled by the control signal. The control signal may take many forms in different embodiments, but it controls the switching arrangement effectively to produce a square wave output. This is then smoothed and filtered by the filtering arrangement, which may include both differential and common mode chokes.

Preferably, the filtering arrangement also includes at least one filtering capacitor. Preferably, filtering capacitors are provided on each of the two output lines from the switching arrangement. Preferably, the filtering capacitors are provided on each of the output lines, between the differential choke and the common mode choke. Each filtering capacitor couples a respective output line to the ground (usually the negative side) of the DC power supply.

After passing through the filtering arrangement, the output lines are connected respectively to a working electrode and counter electrode in an electrochemical cell. Both of these electrodes are isolated from the ground on the supply side, i.e. from the negative side of the DC power supply.

The purpose of the filtering arrangement is to turn the high frequency (e.g. around 20 kHz or higher) square wave into a smooth DC output. Hence an output is achieved which is both smooth and accurately controllable.

A smooth supply to the electrochemical cell is critical. Unlike in other high-power DC control applications, for example DC motor control, an electrochemical cell has negligible inductance. This means that a high frequency switched output will produce a stop-start motion of charged particles in the cell, adversely affecting the formation and morphology of catalytic oxides. In the invention, the two stage filter comprising a differential choke and a common mode choke remove the high frequency switching noise.

A current measurement device may be provided, typically between the counter electrode and its respective output line.

A voltage measurement device may be provided. Typically this is provided between the working electrode and a third electrode, the reference electrode. The reference electrode flows no current in use. Its purpose is to sense the potential of ions in a patch of electrolyte in the cell.

The working electrode is typically treated as the reference point, or ground, in the circuit. In some embodiments the working electrode may be physically connected to earth, and/or a chassis ground. However, it must be isolated from the ground on the supply side, i.e. from the negative side of the DC power supply. Typically, this is achieved by not earthing the DC power supply and treating the negative side of the DC power supply as a floating ground. In other words, the DC voltage at the working electrode is floating relative to the DC voltage of either of the terminals of the DC power supply.

Note that the counter electrode can be either positive or negative compared to the grounded working electrode. This means that all filtering capacitors must be connected to the floating negative side of the DC supply, and not to the grounded working electrode.

At least one of the electrodes may be made from stainless steel. Nickel, manganese and stainless steel alloys have all proved potentially suitable. The electrodes may be provided in the form of woven mesh, sintered felt, foam, expanded sheet metal, or another suitable form.

In the simplest embodiment, it is the working electrode which is being treated. However, it is possible to treat both the working electrode and the counter electrode.

All three electrodes are submerged in an electrolyte, typically an alkaline liquid electrolyte containing an abundance of hydroxide ions. A concentrated solution of potassium hydroxide is a suitable electrolyte.

The current measurement device and/or voltage measurement device may provide signals which feed back into the control system. The control system is typically implemented at least partly in software, and complex and configurable feedback control may be provided. Typically, the control system includes a PID (proportional, integral, derivative) controller.

The device with feedback control is in effect a high power potentiostat, and is suitable for use in a range of electrochemical applications, in particular for supplying a controlled current in a three electrode cell.

A typical control scheme might begin by ramping up the voltage until the current through the cell is at a predetermined value. The voltage required to drive this current is measured and stored.

Typically, the control scheme may set the current through the cell in terms of a current per unit area of the electrode. The area of the electrode being treated may therefore be a parameter to be entered into the control system. A typical value for the initial current per unit area may be for example 0.1 A cm⁻².

Then the voltage is cycled through a triangular waveform, sweeping slowly up and down for example from −1V to +2V and then back, repeatedly. In this sweeping mode the control system uses feedback control from the voltage measurement device to accurately control the voltage. The voltage-current plot will typically sweep through all four quadrants, i.e. current will flow in both directions as power is supplied or absorbed, with both positive and negative applied voltages. The current may be measured while this is going on to create such a plot.

As the voltage between the working and counter electrodes is swept in this way, charged ions are driven across the cell. The potential is controlled so that the working electrode experiences both reduction and oxidation reactions, including the separation of water into hydrogen and oxygen by electrolysis. Each sweep causes growth of metallic oxides on the surface of the raw material. The voltage sweep can be optimised to form the most catalytic oxides and optimise the structural form of oxide growth.

Different voltage sweep control programs may be provided to optimise catalytic action for a particular reaction. The focus of the inventors' work has been the oxygen evolution reaction, since this is typically the rate limiting reaction in green hydrogen production. However other reactions may be optimised for example for production of biofuels and reduction of CO₂. Catalytically active electrodes may also find uses in batteries.

Periodically, the control system may return to a test mode, where the control signal is controlled until the current through the cell is at the predetermined value, say 0.1 A cm⁼². The voltage required to drive this current is measured. If the voltage required to drive this predetermined current has dropped by an amount since it was measured at the start of the process, then the treatment of the electrode may be considered complete. Therefore the sweeping voltage treatment process may be carried out for a period, for example a few minutes, followed by a test to see whether the voltage required to drive the predetermined current has dropped sufficiently. If it has not, then the treatment may be repeated. When the voltage to drive the predetermined current has dropped sufficiently, treatment may be stopped automatically. In some systems, information from testing may be used to control other aspects of the process such as pumps to replace electrolyte. For example, if electrodes start taking more than a certain number of treatment cycles to reach the target voltage drop, this may be an indication that electrolyte needs replacing, which in some embodiments could be automated.

### BRIEF DESCRIPTION OF THE DRAWINGS

For a better understanding of the present invention, and to show more clearly how it may be carried into effect, reference will now be made by way of example only to the accompanying drawings, in which:

FIG. 1 shows a schematic of an apparatus according to the invention, supplying a three electrode cell;

FIG. 2 shows a voltage-current plot across six sweeps to treat an electrode using the apparatus of the invention;

FIG. 3 shows a voltage-current plot over thirty-two sweeps at the top and shows the same data set plotted against time below;

FIG. 4 is a photograph of a prototype experimental setup for treating 50 cm² electrodes, with treated electrodes inset; and

FIG. 5 is a micrograph showing the treated surface of a metallic felt electrode, showing individual fibres.

### DESCRIPTION OF PREFERRED EMBODIMENTS

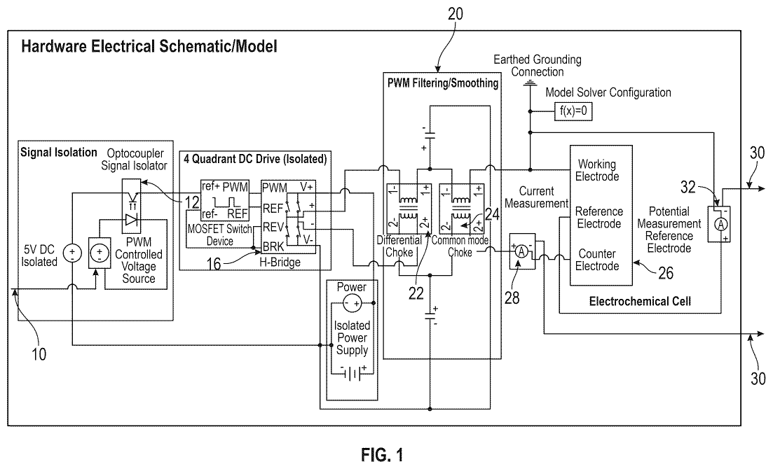

Referring firstly to FIG. 1, an apparatus supplying current to an electrochemical cell is shown schematically. At 10 an input from a control system is provided. The control signal in this embodiment is a PWM-modulated voltage signal. This is isolated via an opto-isolator 12, which essentially regenerates the signal, keeping the signal generator electrically isolated from the rest of the components shown.

The output from the opto-isolator 12 is used to drive a switching arrangement 14. The switching arrangement includes an H-bridge which in turn includes four switching elements, for example MOSFETs. The MOSFETs are driven according to the input from the signal generator, and the output from the H-bridge follows the PWM waveform of the input, but at much higher power.

Although a PWM-modulated voltage signal has certain advantages, for example the ability to isolate it straightforwardly using an opto-isolator, other approaches are possible. For example, the control signal could be a digital signal on an isolated data bus, with the switching arrangement having control circuitry for control by the digital signal.

Another alternative control signal is an analogue voltage signal, or some other kind of modulated signal, which could be provided by the control system. Any signal is suitable as long as it can be used to control (directly or indirectly) the switching arrangement.

The two-wire output from the H-bridge passes to a filtering and smoothing arrangement 20. The filtering and smoothing arrangement comprises a differential choke 22, in series with a common mode choke 24. Coupling capacitors are provided between each of the two wires between the differential choke and the common mode choke, and the negative side of the DC power supply. These parts together provide an effective low pass filter which rejects high frequency switching noise and provides a smoothed output to the electrochemical cell.

The two-wire output of the filtering arrangement 20 is then connected to a working electrode and counter electrode in an electrochemical cell. A current measurement device 28 is provided, for measuring the current flowing in the circuit from the working electrode to the counter electrode (or indeed, in the other direction). The current measurement device 28 provides an electronic signal 30 which can be fed back into the control system, to allow feedback control of the control signal.

A reference electrode is also provided. The reference electrode flows no current, but a voltage measurement device 32 is provided to measure the potential between the working electrode and the reference electrode-essentially, the potential of the ions in a patch of electrolyte within the cell. The voltage measurement device 32 provides an electronic signal 34 which can be fed back into the control system.

Note that the working electrode is considered to be the reference (zero) point for voltage measurement. In some embodiments the working electrode is physically connected to earth as is shown in the drawing. However, this is isolated from the supply ground (negative side of the DC power supply) before the filtering stages. The coupling capacitors in the filtering stage are coupled with the negative side of the DC supply and not with the physical earth.

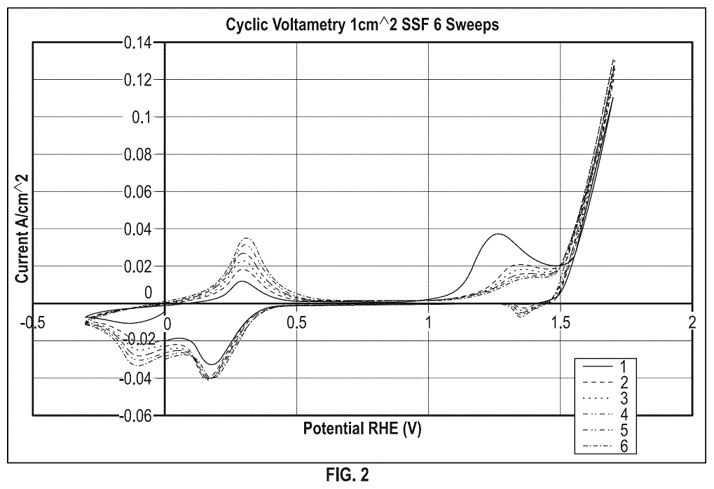

FIG. 2 shows a voltage-current plot over six sweeps through a triangular voltage waveform as the working electrode is treated. As the oxide evolves on the surface of the electrode, more current flows at each stage. Note that all four quadrants of the plot are used, since during the sweeps the electrodes will undergo both reduction and oxidation reactions, and the apparatus will both supply and absorb power.

Typically, to treat an electrode there would be more than six sweeps, for example up to about thirty.

It may be seen that for each subsequent run, the voltage required to pass a set amount of current (i.e. the intercept with a horizontal line on the graph) is reduced. Over several sweeps the OER overpotential is typically reduced by 100 mV or more. This represents a significant improvement when an electrode is used in an electrolyser to produce hydrogen, since the electrolyser will use less power to produce the same amount of hydrogen.

The growth of the smaller peaks is significant as it shows the growth of catalytic oxides at specific voltages during the treatment.

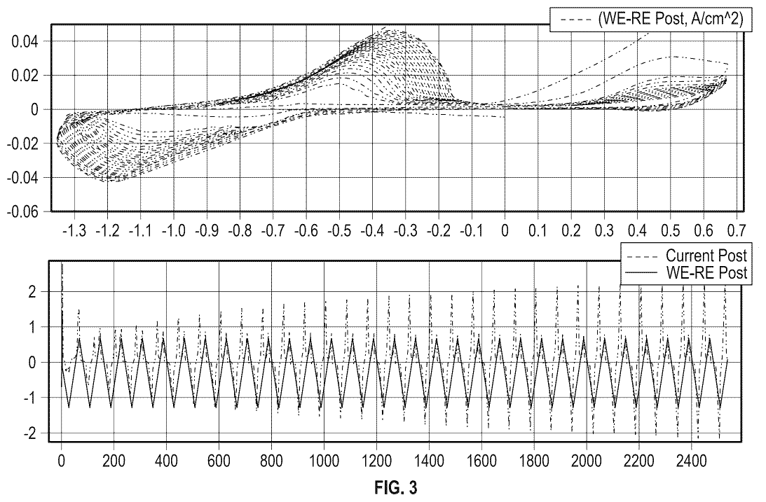

FIG. 3 shows (top) a voltage-current plot over thirty-two sweeps. The plot at the bottom of FIG. 3 shows the exact same data but with time (seconds) on the x-axis. The two lines on the lower graph are controlled voltage, which is a triangular wave with maximum and minimum peaks at the same voltage level on every cycle, and measured current, which increases with each cycle despite the applied voltage being the same each time.

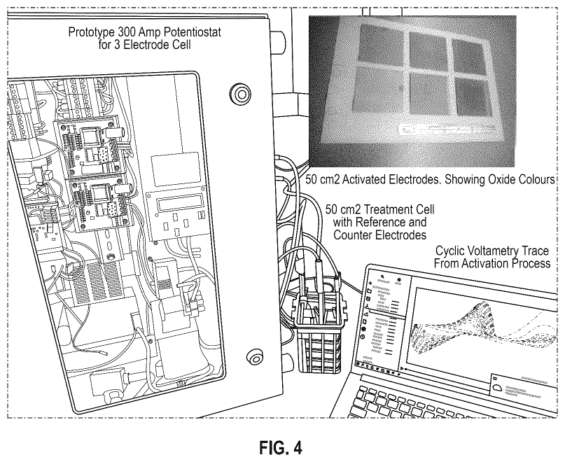

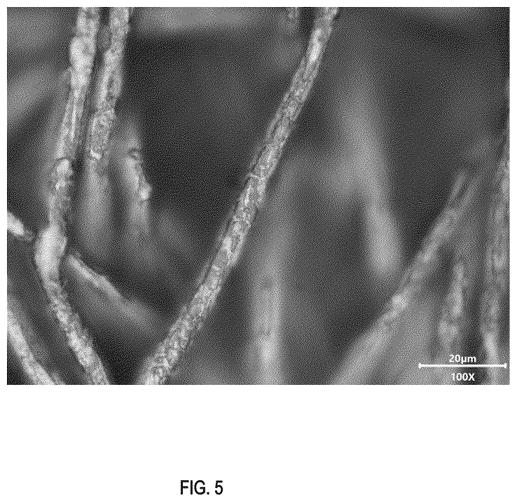

FIG. 4 shows a prototype setup for treating 50 cm² electrodes. The apparatus of the invention is housed in a cabinet, and connected to the working, reference and counter electrodes which are immersed in an electrolyte cell. Inset in the photograph are examples of electrodes treated by the apparatus. Oxides have been evolved on the surfaces of electrodes, increasing their catalytic activity. FIG. 5 shows a 100X micrograph of the treated electrode surface.

The embodiments described above are provided by way of example only, and various changes and modifications will be apparent to persons skilled in the art without departing from the scope of the present invention as defined by the appended claims.

1-21. (canceled)

22. An electrochemical treatment system comprising an electrochemical cell and an apparatus for supplying a smoothed direct current to electrodes in the electrochemical cell, the apparatus comprising:
a control system for producing a control signal;
a DC power supply having positive and negative terminals;
a switching device configured to switch the DC power supply according to the control signal from the control system by pulse width modulation; and
a filtering arrangement connected to an output of the switching device, for smoothing the output from the switching device and providing a pair of smoothed output terminals for connection to electrodes in an electrochemical cell, the filtering arrangement including a capacitor on each of the output lines from the switching device, each capacitor coupling a respective output line with a ground of the DC power supply,
DC isolation being provided between the smoothed output terminals and the positive and negative terminals of the DC power supply,
in which the output from the filtering arrangement is connected to a working electrode and counter electrode of the electrochemical cell.

23. Apparatus as claimed in claim 20, in which the switching device includes an H-bridge circuit having two input lines, two output lines, and four switching elements, a first switching element being provided between the first input line and the first output line, a second switching element being provided between the second input line and first output line, a third switching element being provided between the first input line and the second output line, and a fourth switching element being provided between the second input line and the second output line.

24. Apparatus as claimed in claim 21, in which the switching elements are transistors.

25. Apparatus as claimed in claim 22, in which the transistors are MOSFETs.

26. Apparatus as claimed in claim 20, in which the control system is electrically isolated from the switching arrangement.

27. Apparatus as claimed in claim 24, in which an opto-coupler is provided for isolating the control system from the switching arrangement.

28. Apparatus as claimed in claim 20, in which the DC power includes a battery.

29. Apparatus as claimed in claim 20, in which the filtering arrangement includes a differential mode choke and a common mode choke, and in which the output from the switching device passes through the differential mode choke and then through the common mode choke, the chokes being arranged in series with each other.

30. Apparatus as claimed in claim 27, in which the filtering arrangement includes a capacitor on an output line from the switching arrangement, between the differential choke and the common mode choke.

31. An electrochemical treatment system as claimed in claim 20, in which a current measurement device is provided for measuring a current flow between the working electrode and the counter electrode.

32. An electrochemical treatment system as claimed in claim 29, in which the current measurement device provides a signal for feedback control of the control system.

33. An electrochemical treatment system as claimed in claim 20, in which a voltage measurement device is provided for measuring a potential between one of the working electrode and the counter electrode and a region of electrolyte within the electrochemical cell.

34. An electrochemical treatment system as claimed in claim 31, in which a reference electrode is provided, the voltage measurement device being configured to measure the potential between one of the working electrode and the counter electrode, and the reference electrode.

35. An electrochemical treatment system as claimed in claim 32, in which the voltage measurement device provides a signal for feedback control of the control system.

36. An electrochemical treatment system as claimed in claim 33, in which at least one of the electrodes is made from stainless steel.

37. An electrochemical treatment system as claimed in claim 20, in which the electrochemical cell contains an alkaline liquid electrolyte having hydroxide ions.

38. An electrochemical treatment system as claimed in claim 35, in which the electrolyte is potassium hydroxide.

39. An electrochemical treatment system as claimed in claim 20, in which the control system includes a PID controller.

40. An electrochemical treatment system as claimed in claim 20, in which the PWM switching frequency is higher than 20 kHz, preferably higher than 100 kHz.
